(19) United States
(12) Patent Application Publication
(10) Pub. No.: US 2009/0255856 A1
(43) Pub. Date: Oct. 15, 2009

(54) Device for Delivering Bulk Material Stored in a Supply Container

(75) Inventors: Kurt GNANN, Biberach (DE); Harald Mauz, Ehingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Uhlmann Pac-Systeme GmbH & Co. KG, Laupheim (DE)

(21) Appl. No.: 12/422,789

(22) Filed: Apr. 13, 2009

(30) Foreign Application Priority Data
Apr. 14, 2008 (EP) 08 007 280.4

(51) Int. Cl. B07B 1/00

(52) U.S. Cl. 209/233

(57) ABSTRACT

The device for delivering bulk material has a supply container having a product outlet with an outlet opening which has a rectangular shape. Further, is has a perforated plate having a hole-free product inlet surface arranged underneath the product outlet of the supply container. The perforated plate serves to receive individual products from the product outlet and to move them further in a transport direction while removing broken products and dust. The hole-free product inlet surface of the perforated plate has a surface width in a direction perpendicular to the transport direction and the outlet opening of the product outlet of the supply container has an opening width in a direction perpendicular to the transport direction, the opening width corresponding to 60-95% of the surface width.

### BACKGROUND OF THE INVENTION

1. Field of the Invention

The invention pertains to a device for delivering bulk material consisting of individual products stored in a supply container to a transfer unit, which transfers the individual products into the pockets of a continuously or cyclically moving web of sheeting. The device is provided with a perforated plate arranged downstream of the product outlet of the supply container.

2. Description of the Related Art

These types of devices are used in particular as part of a work station in thermoforming machines to deliver the individual products to be packaged in blister packs to the transfer unit for further processing. The individual products are dispensed as bulk material through the outlet opening of the product outlet of the supply container onto the perforated plate, which serves to convey a product “carpet”, consisting as far as possible of a single layer, toward the transfer unit and at the same time to discharge dust and breakage through the holes of the perforated plate. The perforated plate may not have any holes directly underneath the outlet opening of the product outlet, because the individual products lying on the perforated plate would be pressed down onto the perforated plate by the product column on top of them, as a result of which the edges of the holes could cause damage to the products and result in more breakage, which would then have to be separated afterwards. However, the desired even distribution of the products over the entire width of the perforated plate lead to the need for relatively long perforated plates.

### SUMMARY OF THE INVENTION

It is an object of the present invention to design a device of the type indicated above in such a way that the effectiveness with which dust and breakage are discharged from the perforated plate is increased and/or the size of the perforated plate is reduced.

According to an aspect of the invention, the device for delivering bulk material consisting of individual products comprises: a supply container for storing the bulk material of individual products, the supply container having a product outlet with an outlet opening which has a substantially rectangular shape; at least one perforated plate having a hole-free product inlet surface arranged underneath the product outlet of the supply container, the at least one perforated plate serving to receive the individual products from the product outlet and to move them further in a transport direction while removing broken products and dust; wherein the hole-free product inlet surface of the at least one perforated plate has a surface width in a direction perpendicular to the transport direction and the outlet opening of the product outlet of the supply container has an opening width in a direction perpendicular to the transport direction, the opening width corresponding to 60-95% of the surface width.

As a result of this design, the first advantage is obtained that better use is made of the available length of the perforated plate, because, in contrast to a round outlet opening of the product outlet, the product inlet surface can be smaller, in particular shorter. Another advantage is obtained in that the opening width of the outlet opening is adapted to the surface width of the perforated plate and its product inlet surface, respectively. Thus, the perforated plate does not need to be very long in the transport direction to allow the product carpet to fan out over the entire width of the perforated plate.

It has been found especially favorable within the scope of the invention for the outlet opening to comprise an opening width of 75-85% of the surface width of the perforated plate. The length of the outlet opening preferably equals 2-12 times, especially 5-8 times, the size of the products. This design makes very efficient use of the area of the perforated plate, efficiency being defined here as the ratio between the area under the product outlet and the effective surface area of the perforated plate, because the product inlet area is coordinated in the transport direction to the size of the outlet opening, which is based in turn on the size of the individual products, wherein the device also makes it quite possible to process individual products of different sizes within the scope of the ranges indicated above.

It is also favorable for the product inlet surface to comprise a surface area of 3-8-times the opening area of the outlet opening, because this makes it possible for the individual products from the product column to fan out into a product carpet before the they reach the holes of the perforated plate, which reduces the danger of breakage. The load on the products is also reduced because, as a result of the substantially rectangular design of the outlet opening, the volume of the product column above the product inlet surface is smaller, which means that the volume through which the individual products flow in the area of the product outlet is also smaller. Although the same number of individual products may be passing through this area, the time the individual products spend in the product column is shorter, and thus the danger that the individual products in the product column will be damaged is also reduced.

It is also preferred within the scope of the invention to provide several perforated plates arranged in a row perpendicular to the transport direction. With this design, the output of the inventive device can be easily increased considerably, in that two perforated plates, arranged next to each other, are used. With this design, highly efficient use is made of the product outlet, this efficient use being defined as the ratio between the width of the product outlet and the effective useful width of the perforated plates. In the case of the inventive design, an efficiency of approximately 0.9 is obtained, which is significantly higher than that of the previously known designs.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of an exemplary embodiment, which is illustrated in the drawings.

FIG. 1 is a perspective view of one embodiment of the device according to the invention;

FIG. 2 is a view in the direction of the arrow 11 in FIG. 1;

FIG. 3 is a perspective view of an isolated plate holder of a base stand with associated perforated plates and clamping strips;

FIG. 4 is an enlarged side view of the detail marked “IV” in FIG. 3;

FIG. 5 is an enlarged side view of the detail marked “V” in FIG. 3;

FIGS. 6a-6c are three side views showing the separation of the clamping screw from the clamping strip;

FIG. 7a is a perspective view of the perforated plate from above;

FIG. 7b is a perspective view of the perforated plate from below;

FIG. 8 is a schematic top view of the perforated plate including a sketch of the outlet opening of the supply container and the product inlet surface of the perforated plate;

FIG. 9 is a side view of the plate holder with a bulk material leveler in a first rotational position;

FIG. 10 is a view corresponding to FIG. 9 with the bulk material leveler in a second rotational position;

FIG. 11 is a view of the preparation for the removal of the bulk material leveler; and

FIG. 12 is a view corresponding to FIG. 11 after the bulk material leveler has been removed from the plate holder.

### DETAILED DESCRIPTION OF THE PRESENTLY PREFERRED EMBODIMENTS

Thermoforming machines are used especially in the pharmaceutical industry to package individual products such as tablets, dragées, pills, or the like in blister packs, for which purpose thermoplastic sheet is pulled in the form of a web of sheeting from a supply roll in the thermoforming machine and sent to a heating station, in which the thermoplastic sheet is heated to the preforming temperature, and then to a forming station, in which the pockets of the blister packs are formed. In order to facilitate the filling of the pockets in the web of sheeting, the device according to the invention serves as a connecting element between a product supply and a transfer unit, which transfers the individual products into the pockets in the web of sheeting.

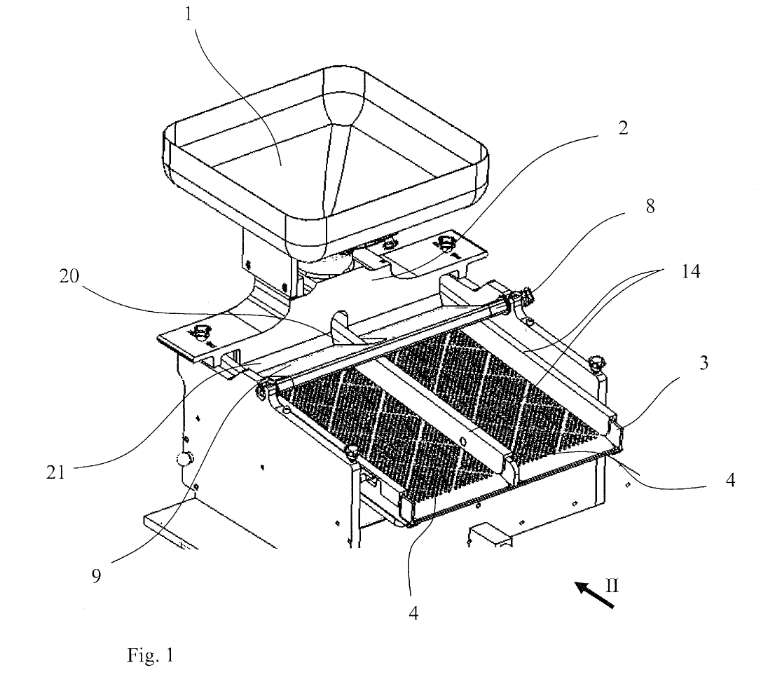

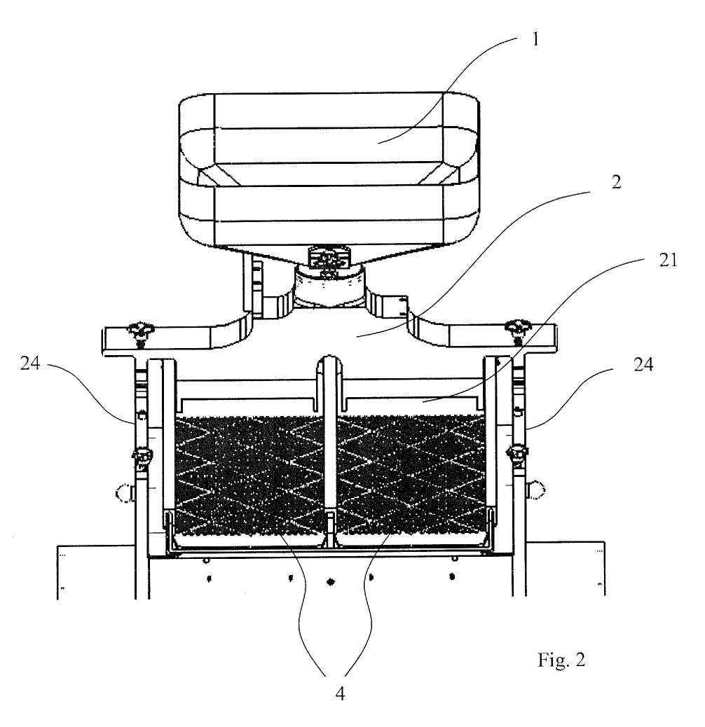

FIGS. 1 and 2 show the device, which comprises for this purpose not only the supply container 1 with its product outlet 2 but also a perforated plate 4, which is mounted detachably and replaceably downstream from the product outlet 2, in a plate holder 3 of a base stand 24. In the exemplary embodiment shown here, several of these perforated plates 4 are present, specifically two of them arranged in a row perpendicular to the transport direction of the individual products, so that as a result a large effective width of the device is obtained by very simple means.

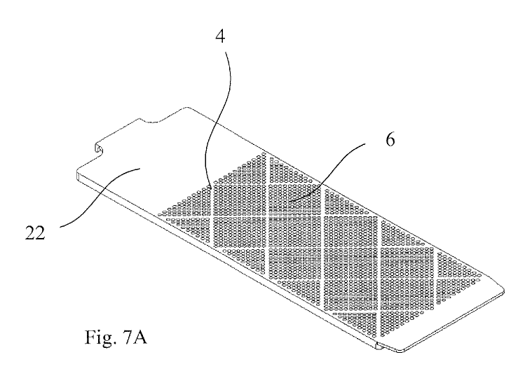

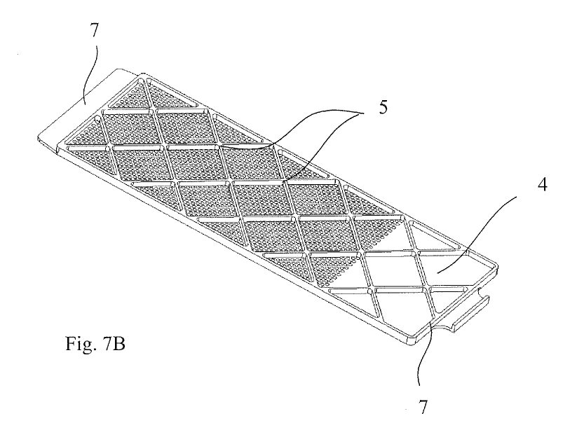

Each perforated plate 4 comprises a plurality of holes adapted to the diameter and the shape of the individual products. The holes hold back intact individual products on the surface of the perforated plate 4 but allow breakage and dust to pass through. On the side of the perforated plates 4 facing away from the individual products are stiffening ribs 5 (FIG. 7b), which slant inward from the opposing lateral edges and divide the rectangular perforated plate 4 into separate areas 6, wherein the holes are formed only in the areas 6 of the perforated plate 4 between the stiffening ribs 5. Support surfaces 7 without stiffening ribs 5 may be provided at the leading and trailing ends (with respect to the transport direction) of the perforated plates 4. These support surfaces allow the perforated plate 4 to lie in a defined position in the base stand 24 and also make it easier to connect the vibratory drive provided to convey the products from the product outlet 2 to the transfer unit (not shown). Because the plurality of perforated plates 4 can be arranged in a single base stand 24, one vibratory drive is usually sufficient, which offers a corresponding cost advantage. In addition, to support the action of the vibratory drive, it is also possible, of course, for the base stand 24 to slant downward in the transport direction so as to take advantage of the force of gravity.

The surface area directly under the product outlet 2 cannot be used to separate breakage, i.e., it should not have any holes in it, because the individual products lying on the perforated plate 4 would be pressed onto the perforated plate 4 and against the edges of the holes by the product column lying on top of them, and the vibratory movements of the perforated plate 4 could thus damage the individual products.

The general boundary conditions are that the device should occupy the smallest possible amount of space and have the highest possible output at the same time. A contribution toward achieving both of these objects is provided in that the outlet opening 21 of the product outlet 2 comprises a substantially rectangular shape having an opening width which is adapted to a surface width of the perforated plate 4 and a length, i.e., a dimension in the transport direction of the individual products, which is adapted to the size of the individual products.

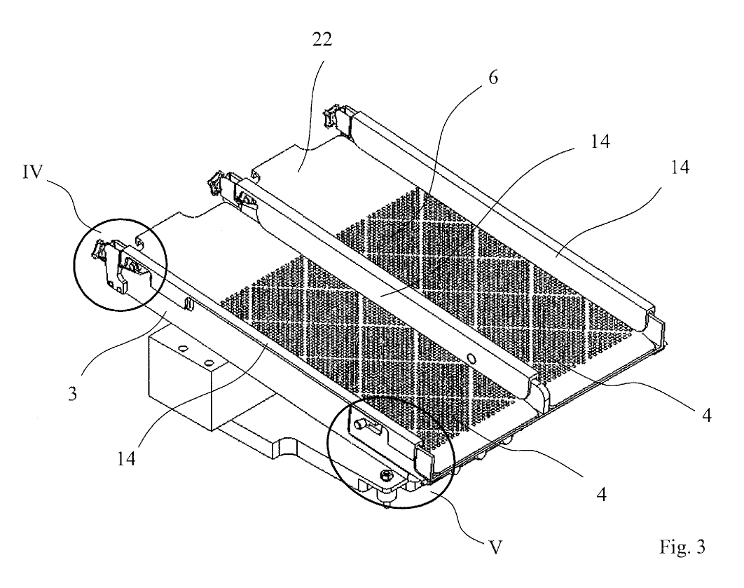

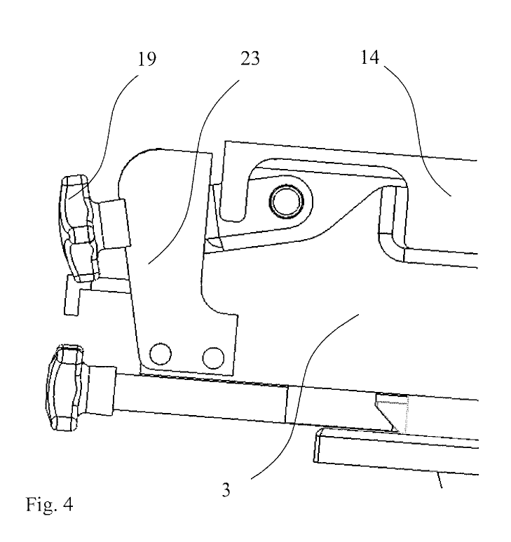

The perforated plate 4 comprises, underneath the product outlet 2, a hole-free product inlet surface 22 (see FIG. 3) adapted to the length of the outlet opening 21. The length of the hole-free product inlet surface 22 will in general be somewhat larger than the length of the outlet opening 21. It is therefore provided in the device that as much of the width of the perforated plate 4 as possible is used for product distribution when the individual products are deposited onto the perforated plate 4, which means that the outlet opening 21 of the product outlet 2 is adapted to this requirement. Choosing an appropriate shape for the outlet opening 21, namely, a skinny rectangle or a similar shape, for example an elongate oval, makes it possible to reduce the length of the hole-free area of the perforated plate 4, that is, the length of the product inlet surface 22, and therefore to minimize the area which does not contribute to breakage separation.

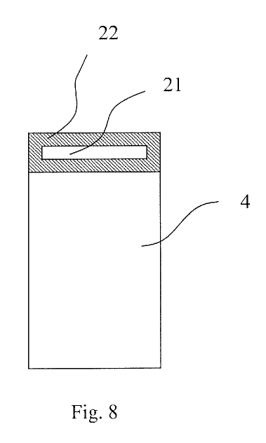

When the individual products are delivered through a small round outlet opening according to the prior art, they must travel a longer distance in the transport direction before they can spread out evenly from the edges of the product outlet 21 to the edges of the perforated plate 4, whereas, when the products are delivered through the substantially rectangular opening (FIG. 8), they become evenly distributed from edge to edge after traveling a much shorter distance.

It has been found favorable for the outlet opening 21 to be rectangular in design with an opening width equal to 60-95%, preferably 75-85%, of the surface width of the perforated plate 4 and its hole-free product inlet surface 22, respectively. The length of the outlet opening 21 preferably corresponds to 2-12 times, especially 5-8 times, the size of the products. Altogether, an overall surface area of the product inlet surface 22 comprises 3-8 times the size of an opening area of the outlet opening 21.

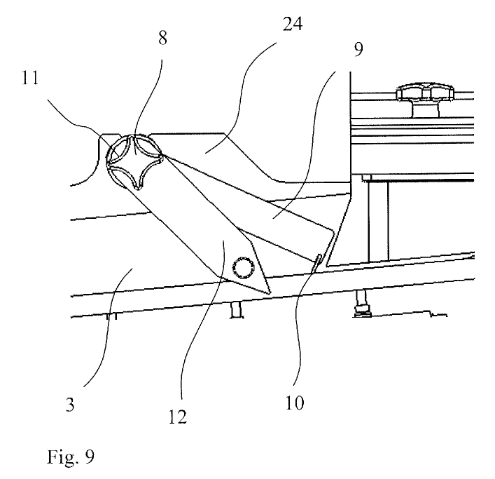

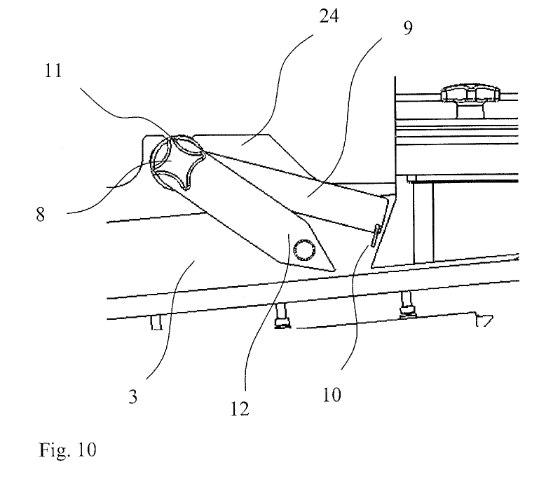

When the individual products are transferred from the supply container 1 to the transfer unit, it is important for the individual products to form a layer on the perforated plate 4 which is only one deep. Therefore, downstream from the product outlet 2, above the perforated plate 4, a bulk material leveler 9 formed as a leveler strip is mounted rotatably on a pivot axis 8 (see FIG. 9). So that the perforated plates 4 located underneath the bulk material leveler 9 can be replaced, the leveler is connected detachably to the base stand 24. The bulk material leveler 9 comprises an elastic lip 10 on its free end facing the perforated plate 4 to ensure that the individual products are treated gently. The rotational position of the bulk material leveler 9 can be set by means of a positioning element 11, preferably a clamping screw with a T-handle, so that the bulk material leveler 9 can be adjusted to suit the size of the individual products (FIG. 10). An adjusting lever 12 is provided on the clamping screw itself.

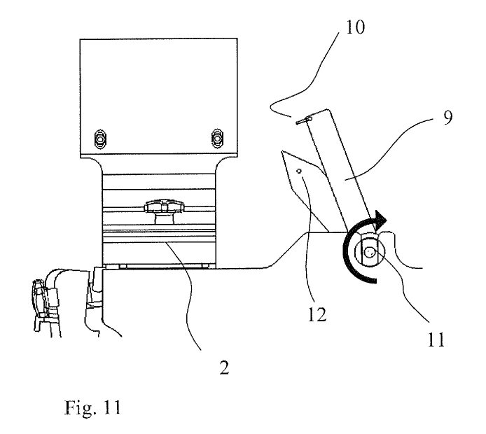

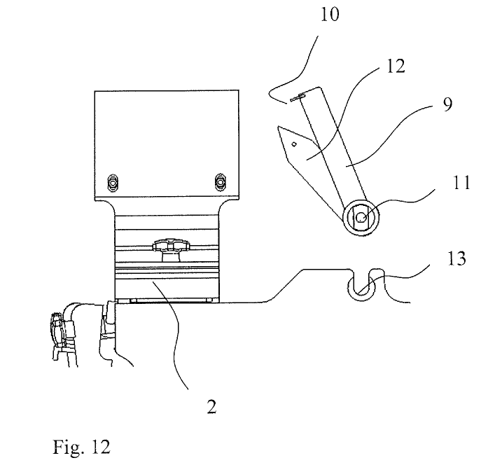

When the type of the individual products to be packaged in the pockets of the web of sheeting is to be changed, it is also necessary to replace the old perforated plate with a new one with holes adapted to the size and shape of the new individual products, so that, to achieve the shortest possible setup time for the device, it should be possible to accomplish such a change easily, quickly, and by a single person if at all possible. To replace the perforated plates 4, therefore, first the clamping screw is loosened, and then the adjusting lever 12 is used to rotate the bulk material leveler 9 (FIG. 11) in such a way that it can be removed by pulling it upward out of its screw receiving groove 13 (FIG. 12), which is open in the upward direction.

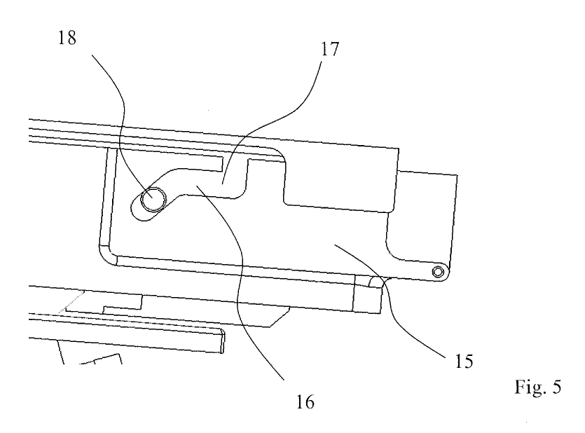

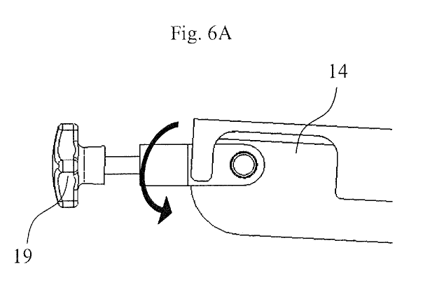

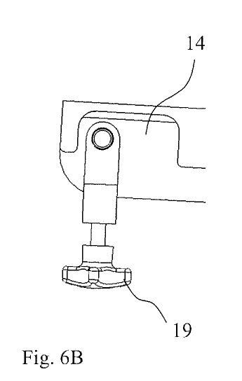

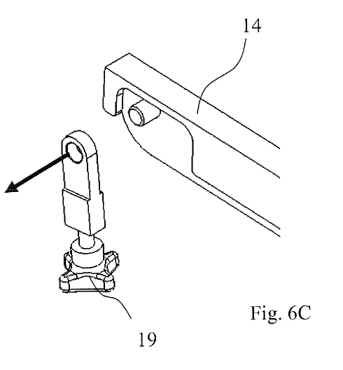

The reason that the perforated plates 4 can be replaced easily is that the plate holders 3 on which the clamping strips 14 are arranged are designed as motion guideway carriers 15 (FIG. 5). Each clamping strip 14 is supported in a motion guideway 16 of the motion guideway carrier 15. The motion guideway 16 extends at an angle to the vertical and is formed as a guide slot 17, which is open at one end and into which the guide pin 18 of the clamping strip 14 can thus be inserted. At the end of the clamping strip 14 near the product inlet surface 22, a clamping means, preferably a clamping screw 19, is provided, which engages in a screw block 23, which extends downward at an angle to the vertical. The angle of the motion guideway 16 may preferably correspond to the angle of the clamping screw 19, so that, when the clamping screws 19 are turned in the clamping direction, the clamping strip 14 as a whole is pulled downward at this same angle and the perforated plate 4 is thus clamped to the plate holder 3 and thus the base stand 24. To make it even easier to clean the device, the clamping screw 19 may be connected detachably to the clamping strip 14 (FIGS. 6a-6c). However, apart from the preferred embodiment described above, a number of other clamping means for fixing the clamping strip 14 may be used as long as they provide proper and even clamping of the clamping strip 14 onto the perforated plate 4.

FIGS. 1-3 show that several clamping strips 14 are provided in an arrangement assigned to the lateral edges of the perforated plates 4. Because, in the case of the exemplary embodiment shown here, two perforated plates 4 are present, located one next to the other, the middle clamping strip 14 serves to act on two lateral edges, namely, on one of the edges of the perforated plate 4 on the left and on one of the edges of the perforated plate 4 on the right. The presence of the middle clamping strip 14 also means that an opening 20 must be provided in the bulk material leveler 9. After the leveler has been removed, the clamping screws 19 can be loosened and the clamping strips 14 pushed along the motion guideway 16, so that the guide pin 18 can be removed via the open end of the guide slot 17. The clamping strip 14 can now be removed from the plate holder 3. The perforated plates 4 are thus freely accessible and can be removed and replaced by new perforated plates 4, for which purpose it is necessary merely to reinsert the guide pins 18 of the previously cleaned clamping strips 14 into the guide slots 17 and to pivot the clamping strips 14 onto the perforated plates so that they can be clamped down again by means of the clamping screws 19.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for delivering bulk material consisting of individual products, the device comprising:
a supply container for storing the bulk material of individual products, the supply container having a product outlet with an outlet opening which has a substantially rectangular shape;
at least one perforated plate having a hole-free product inlet surface arranged underneath the product outlet of the supply container, the at least one perforated plate serving to receive the individual products from the product outlet and to move them further in a transport direction while removing broken products and dust;
wherein the hole-free product inlet surface of the at least one perforated plate has a surface width in a direction perpendicular to the transport direction and the outlet opening of the product outlet of the supply container has an opening width in a direction perpendicular to the transport direction, the opening width corresponding to 60-95% of the surface width.

2. The device according to claim 1, wherein the opening width corresponds to 75-85% of the surface width.

3. The device according to claim 1, wherein the hole-free product inlet surface of the at least one perforated plate comprises a surface area and the outlet opening of the product outlet of the supply container comprises an opening area, the surface area being 3 to 8 times the opening area.

4. The device according to claim 1, wherein several perforated plates are arranged in a row in a direction perpendicular to the transport direction.
